(19) United States
(12) Patent Application Publication
(10) Pub. No.: US 2011/0063599 A1
(43) Pub. Date: Mar. 17, 2011

(54) FILM HOLDER

(75) Inventors: Xian-Jun Wang, Suzhou (CN); Ming-Jie Zhao, Suzhou (CN); Jian-Chun Yu, Suzhou (CN)

(73) Assignee: QISDA (SUZHOU) CO., LTD, Suzhou (CN)

(21) Appl. No.: 12/794,703

(22) Filed: Jun. 4, 2010

(30) Foreign Application Priority Data
Sep. 12, 2009 (CN) 200920169692.7

(51) Int. Cl. G03B 27/62; H04N 5/253

(52) U.S. Cl. 355/75; 348/96

(57) ABSTRACT

A film holder is provided. During scanning of a to-be-scanned object, the film holder is inserted into a scanning device. The film holder includes an input portion, a guiding portion and a leveling portion. The input portion has an entrance, a channel and an exit, the channel disposed between the entrance and the exit. During scanning of the to-be-scanned object, the to-be-scanned object passes through the channel. The guiding portion connects to the input portion for guiding the to-be-scanned object. The leveling portion is disposed on one side of the channel. During scanning of the to-be-scanned object, the leveling portion leans against the to-be-scanned object. The sensing unit stably senses the to-be-scanned object. The to-be-scanned object inside the film holder is kept from being scratched and the to-be-scanned object is in smooth move during scanning.

This application claims the benefit of People's Republic of China application Serial No. 200920169692.7, filed Sep. 12, 2009, the subject matter of which is incorporated herein by reference.

### TECHNICAL FIELD

The invention relates in general to a film holder, and more particularly to a film holder applied in a film scanning device for amending the film deformation and for avoiding the film from being scratched.

### BACKGROUND

Nowadays, various image scanning devices have been widely used in work or everydayness. Examples of the image scanning devices include flatbed scanners or portable scanners with film scanning function, or apparatus capable of converting films, such as positives, negatives, slides and reversal films, into electronic images. During scanning of a film, the user normally places the film into a film holder and inserts the film holder into the scanning device; and scanning of the film is completed via a drive device and a light source.

Referring to FIG. 1, a schematic diagram of a film holder 1 according to the prior art is shown. The film holder 1 is for carrying a to-be-scanned film. The film holder 1 includes an input portion 11 and a guiding portion 12.

During scanning, the film holder 1 is inserted into the film scanning device. The film passes through the input portion 11 and the guiding slot 120 of the guiding portion 12. However, during movement, the film in severe deformation rubs with the input portion 11, for example, at the position 10 of FIG. 1. The film may be scratched and damaged, hence negatively affecting the quality of image scanning.

### BRIEF SUMMARY

To resolve the above problems, according to embodiments of the invention, a leveling device is disposed in the film holder for adjusting the deformation of the film in the film holder. So that the sensing unit can stably sense the to-be-scanned object. The to-be-scanned object inside the film holder is kept from being scratched; and the to-be-scanned object is in smooth move during scanning.

One possible embodiment of the invention provides a film holder for carrying the to-be-scanned object. During scanning of the to-be-scanned object, the film holder is inserted into a scanning device. The film holder includes an input portion, a guiding portion and a leveling portion. The input portion has an entrance, a channel and an exit, wherein the channel is disposed between the entrance and the exit. During scanning of the to-be-scanned object, the to-be-scanned object passes through the channel. The guiding portion connects to the input portion for guiding the to-be-scanned object. The leveling portion is disposed on one side of the channel. During scanning of the to-be-scanned object, the leveling portion leans against the to-be-scanned object.

According to the film holder of the embodiment of the invention, the leveling portion is realized by a cylinder having a rotatable shaft fixed at the input portion. Alternatively, the leveling portion is realized by a slide block disposed at the input portion.

According to the film holder of the embodiment of the invention, the width of the leveling portion is larger than or equal to that of the channel. Alternatively, the leveling portion is disposed along a center of a width direction of the channel.

According to the film holder of the embodiment of the invention, the input portion includes an incoming surface disposed at the entrance and is further extended to the channel. Furthermore, the input portion further includes an upper cover; and the channel is surrounded by the upper cover and the incoming surface.

Furthermore, the leveling portion is disposed on the upper cover; and during scanning of the to-be-scanned object, the to-be-scanned object passes between the leveling portion and the incoming surface.

Furthermore, the input portion further includes a protrusion disposed on the upper cover; and when the film holder is inserted into the scanning device, the protrusion leans against the scanning device.

According to the film holder of the embodiment of the invention, a slide boosting coating is formed on the guiding portion. Further, the slide boosting coating is a PTFE layer.

According to the film holder of the embodiment of the invention, a blocker is further disposed at one end of the guiding portion far away from the input portion. The blocker has a bevel. When the film holder is inserted into the scanning device, the bevel leans against the scanning device.

Embodiments of the invention effectively avoid the to-be-scanned object inside the film holder from being scratched, and make the to-be-scanned object move smoothly during scanning

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a schematic diagram of a prior film holder;

FIG. 2 shows a schematic diagram of a film holder according to an embodiment of the invention;

FIG. 3 shows operations of the film holder according to the embodiment of the invention;

FIG. 4 shows a schematic diagram of a first example of a leveling portion according to the embodiment of FIG. 2;

FIG. 5 shows a schematic diagram of a second example of a leveling portion according to the embodiment of FIG. 2; and

FIG. 6 shows a structural diagram of a scanning device according to another embodiment of the invention, wherein a film holder is inserted into the scanning device.

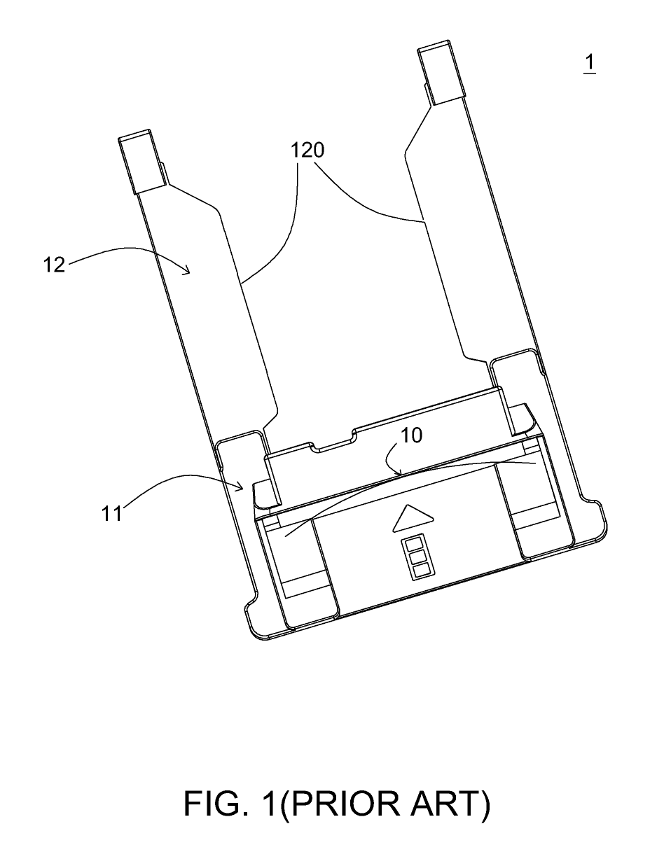

### DETAILED DESCRIPTION OF EXEMPLARY EMBODIMENT OF THE INVENTION

Objects, structures, characteristics and functions of embodiments of the invention are disclosed below with accompanying drawings.

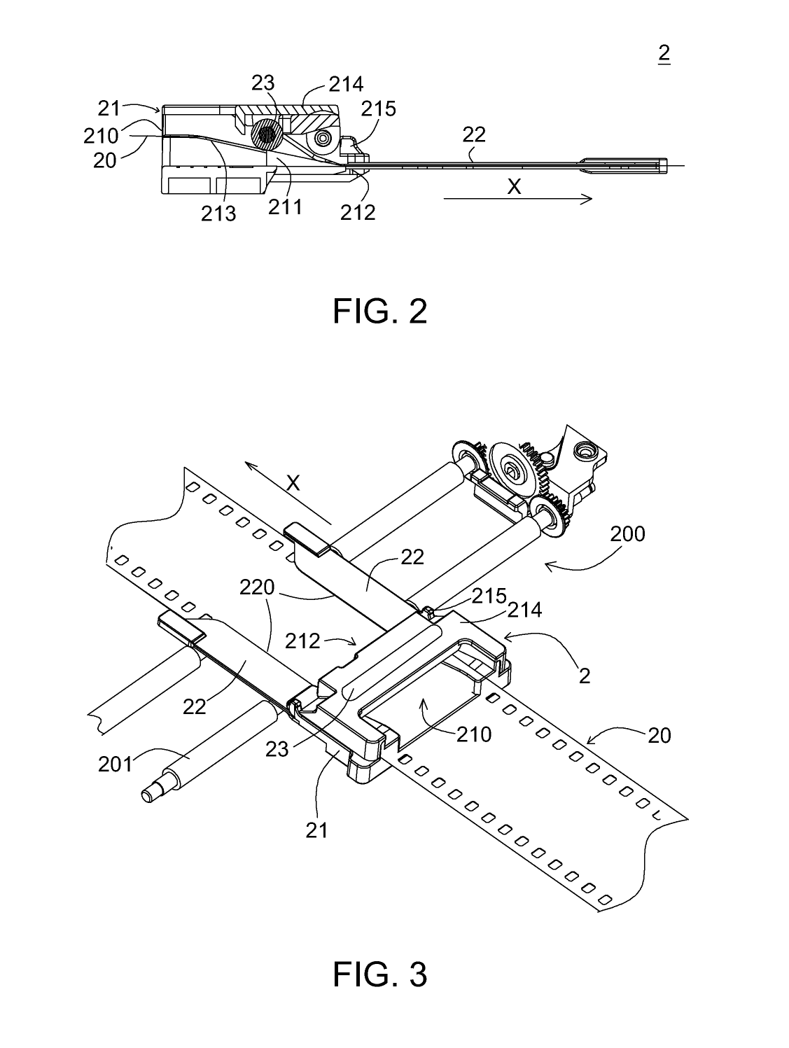

Referring to FIG. 2 and FIG. 3. FIG. 2 shows a schematic diagram of a film holder 2 according to an embodiment of the invention. FIG. 3 shows operations of the film holder 2 according to the embodiment of the invention. The film holder 2 is for carrying a to-be-scanned film 20. During scanning of the film, the film holder 2 is inserted into a scanning device 200 (not illustrated in FIG. 2 but partially illustrated in FIG. 3). The scanning device 200 includes a driving roller 201 for driving the film 20 to move along a first direction X. The film holder 2 includes an input portion 21, a guiding portion 22 and a leveling portion 23. The input portion 21 has an entrance 210, a channel 211 and an exit 212, wherein the channel 211 is disposed between the entrance 210 and the exit 212. During scanning of the film, the film 20 passes through the channel 211. The guiding portion 22 connects to the input portion 21 for guiding the film 20. For example, the guiding portion 22 is disposed at the exit 212, but the invention is not limited thereto. In other possible embodiments, the guiding portion 22 could be made from metal or plastics. The guiding portion 22 is fixed on the input portion 21, or integrally formed in one piece with the input portion 21. In other possible embodiment, a slide boosting coating is formed on the guiding portion 22 for reducing the friction between the film 20 and the guiding portion 22. In practical application, the slide boosting coating could be realized by a PTFE layer. In other possible embodiment, the guiding portion 22 could include two guiding slots 220 opposite to each other. Two lateral sides of the film are respectively received in the two guiding slots 220 of the guiding slot 220. The image region (or the center region) of the film is located between the two guiding slots 220. The guiding slots 220 and the channel 211 are interconnected.

The leveling portion 23 is disposed on one side of the channel 211. During scanning, the leveling portion 23 leans against the film 20 for keeping the film leveled. As indicated in FIG. 2 and FIG. 3, the leveling portion 23 is disposed on an upper side of the channel 211. In other words, the leveling portion 23 and the driving roller 201 are disposed on different sides of the film 20. In practical application, the leveling portion 23 could be independent, or integrally formed in one piece with the guiding portion 22, so as to level the film.

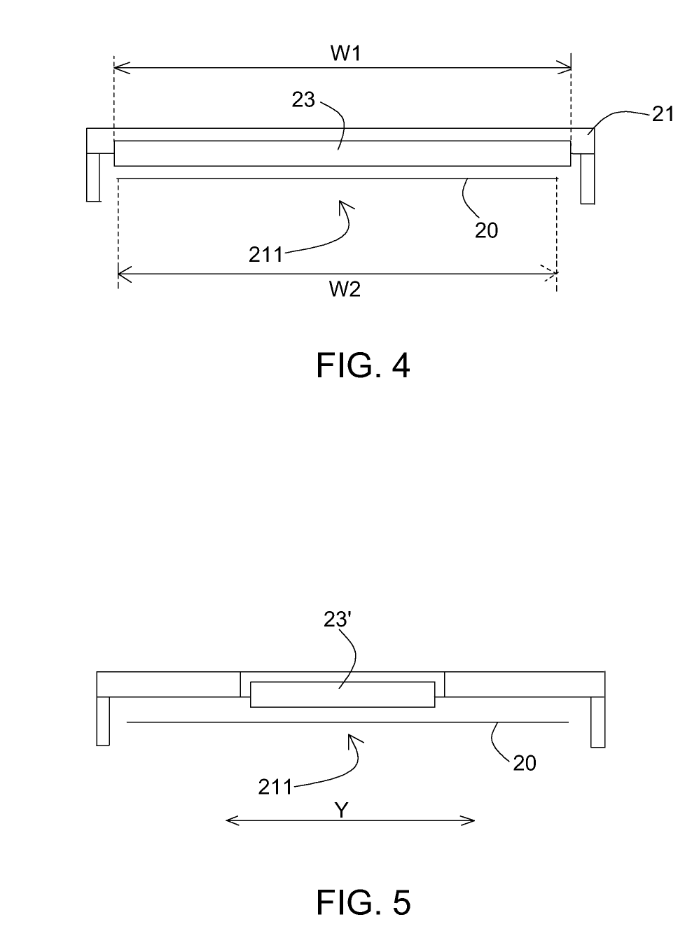

Referring to FIG. 4, a schematic diagram of the leveling portion 23 according to the embodiment of FIG. 2 is shown. The width W1 of the leveling portion 23 is larger than or equal to that of the channel 211; and further the width W1 is larger than or equal to the width W2 of the film 20. In practical application, preferably, the leveling portion 23 is realized by a cylinder whose rotating shaft is fixed at the input portion 21, so as to avoid the surface of the film 20 from being scratched due to the friction between the film 20 and the input portion 21. Also, the leveling portion 23 could be realized by a slide block disposed on the input portion 21. However, the contact surface between the slide block and the film are smooth for reducing the sliding friction.

Referring to FIG. 5, another schematic diagram of the leveling portion 23′ according to the embodiment of FIG. 2 is shown. The leveling portion 23′ is disposed along a center of the width direction Y of the channel 211. In comparison to the leveling portion 23, the position of the leveling portion 23′ is described but the width thereof is not described. In general, the film 20, if deformed, usually curls up from the center. So, the position of the leveling portion 23′ corresponds to the curved center of the film for enhancing leveling of the film. The leveling portion 23′ could be realized by a cylinder or a slide block, and the similarities between the leveling portion 23′ and the leveling portion 23 are not repeated here.

Referring to FIG. 2 and FIG. 3 again. In an embodiment, the input portion 21 includes an incoming surface 213 disposed at the entrance 210; and the incoming surface 213 is further extended to the channel 211. The input portion 21 further includes an upper cover 214 and the channel 211 is surrounded by the upper cover 214 and the incoming surface 213. In practical application, the leveling portion 23 is disposed on the upper cover 214. During scanning, the film 20 passes between the leveling portion 23 and the incoming surface 213. To increase the friction between the film 20 and the driving roller 201 inside the scanning device 200 so that the driving roller 201 can easily drive the film 20, the input portion 21 further includes a protrusion 215 disposed on the upper cover 214. When the film holder 2 is inserted into the scanning device 200, the protrusion 215 leans against the scanning device 200. For example, the protrusion 215 leans against the housing (not illustrated in FIG. 3) of the scanning device 200.

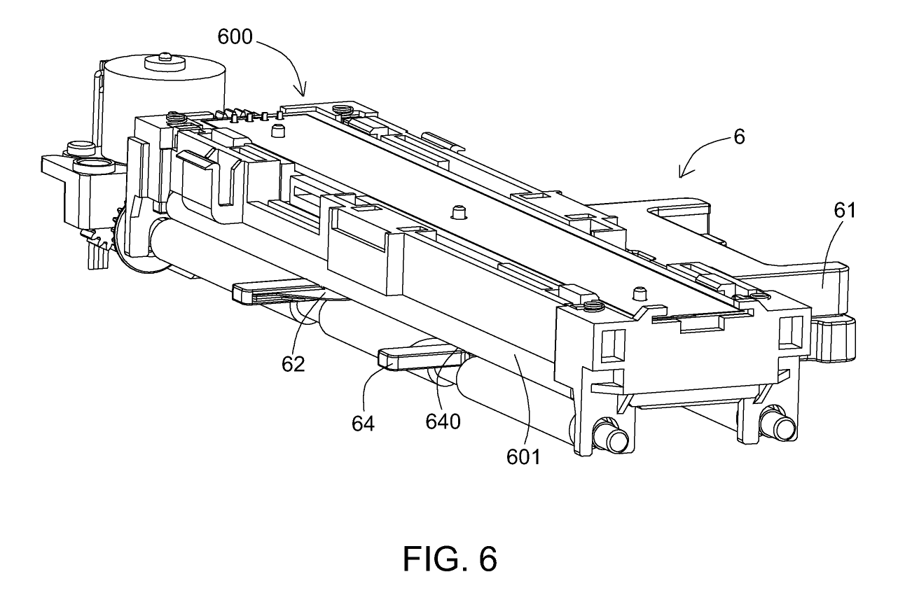

Referring to FIG. 6, a structural diagram of a scanning device 600 according to another embodiment of the invention is shown, wherein a film holder 6 is inserted into the scanning device 600. The film holder 6 includes an input portion 61, a guiding portion 62 and a leveling portion. The similarities between the film holder 6 of the present embodiment and the film holder of the above embodiment are not repeated here. The film holder 6 further includes a blocker 64 disposed at one end of the guiding portion 62 far away from the input portion 61. The blocker 64 has a bevel 640. When the film holder 6 is inserted into the scanning device 600, the bevel 640 leans against the scanning device 600. For example, the bevel 640 leans against the passive roller 601 inside the scanning device 600, so that the passive roller 601 and the bevel 640 generate a pushing force to assist element positioning and to increase the hand feeling.

The film holder of the above embodiments of the invention could also be used for carrying other to-be-scanned objects such as a film with a positive, and the invention is not limited thereto.

Embodiments of the invention effectively avoid the to-be-scanned object inside the film holder from being scratched, and make the to-be-scanned object move smoothly during scanning, hence improving the quality of scanned image.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A film holder for carrying a to-be-scanned object, wherein during scanning of the to-be-scanned object, the film holder is inserted into a scanning device, the film holder comprising:
an input portion having an entrance, a channel and an exit, the channel disposed between the entrance and the exit, wherein during scanning of the to-be-scanned object, the to-be-scanned object passes through the channel;
a guiding portion connecting to the input portion for guiding the to-be-scanned object;
a leveling portion disposed on one side of the channel, wherein during scanning of the to-be-scanned object, the leveling portion leans against the to-be-scanned object.

2. The film holder according to claim 1, wherein the leveling portion is a cylinder having a rotatable shaft fixed at the input portion.

3. The film holder according to claim 1, wherein the leveling portion is a slide block disposed at the input portion.

4. The film holder according to claim 1, wherein a width of the leveling portion is larger than or equal to that of the channel.

5. The film holder according to claim 1, wherein the leveling portion is disposed along a center of a width direction of the channel.

6. The film holder according to claim 1, wherein the input portion comprises an incoming surface and an upper cover; the incoming surface is disposed at the entrance and is further extended to the channel; and the channel is surrounded by the upper cover and the incoming surface.

7. The film holder according to claim 6, wherein the leveling portion is disposed on the upper cover; and during scanning of the to-be-scanned object, the to-be-scanned object passes between the leveling portion and the incoming surface.

8. The film holder according to claim 6, wherein the input portion further comprises a protrusion disposed on the upper cover; and when the film holder is inserted into the scanning device, the protrusion leans against the scanning device.

9. The film holder according to claim 1, wherein a slide boosting coating is formed on the guiding portion.

10. The film holder according to claim 1, further comprising a blocker disposed at one end of the guiding portion far away from the input portion, wherein the blocker has a bevel; and when the film holder is inserted into the scanning device, the bevel leans against the scanning device.
